(19) United States
(12) Patent Application Publication
(10) Pub. No.: US 2026/0228322 A1
(43) Pub. Date: Aug. 6, 2026

(54) DATA CARRIER WITH MACHINE-READABLE SECURITY FEATURE, PRODUCTION METHOD AND AUTHENTICITY CHECK METHOD

(71) Applicant: GIESECKE+DEVRIENT CURRENCY TECHNOLOGY GMBH, Munchen (DE)

(72) Inventors: Stephan STEINLEIN, Munchen (DE); Johann KECHT, Munchen (DE); Thomas GIERING, Kirchseeon (DE); Thomas HAPP, Munchen (DE)

(21) Appl. No.: 19/151,081

(22) PCT Filed: Jan. 25, 2024
(86) PCT No.: PCT/DE2024/100060

§ 371 Date: Jul. 25, 2025

(30) Foreign Application Priority Data
Jan. 26, 2023 (DE) 10 2023 101 913.9

(51) Int. Cl. G06F 21/44

(52) U.S. Cl. CPC G06F 21/44

(57) ABSTRACT

A data carrier has a substrate with at least one transparent plastic layer and two opposing main surfaces. It also includes two opaque-white layers having a white, opaque appearance, which are applied to the opposing main surfaces of the substrate. Each opaque-white layer is made up of a sequence of two or more partial layers, from a lowermost white layer to a top white layer. Additionally, the data carrier features a machine-readable security element that contains a feature substance present in at least one of the partial layers of at least one opaque-white layer.

The invention relates to a data carrier, in particular a document of value or security document, which contains a substrate comprising at least one transparent polymer layer, and which is secured with a machine-readable security feature. The invention also relates to a method of producing such a data carrier. The invention further relates to a method of verifying the authenticity of the data carrier.

Data carriers, such as documents of value or identification documents, but also other articles of value, such as brand-name articles, are often provided with security elements that permit authentication of the data carriers and also serve as protection against unauthorized reproduction.

For some time now, in addition to paper substrates, polymer materials have also been used as substrate materials for banknotes. Polymer banknotes have several advantages over paper banknotes, for instance higher tear resistance. However, it has not yet been possible to secure polymer banknotes to the same degree as banknotes with a paper substrate. The securing of polymer bank notes by adding machine-readable feature materials to a visible print is known. However, only small feature volumes can be introduced into such prints, and a completeness check is usually not possible with the feature-laden prints that are generally only present in some regions. By contrast, if machine-readable feature materials are introduced into the volume of the polymer substrate in order to also allow a completeness check, there is a risk that the feature materials will be visible in transparent window regions and interfere with the appearance.

Proceeding therefrom, it is an object of the invention to improve authenticity assurance of polymer or composite banknotes.

This object is achieved by the features of the independent claims. Developments of the invention are the subject of the dependent claims.

The invention provides a data carrier with a substrate comprising at least one transparent polymer layer and having opposite main surfaces. In particular, the data carrier may be a document of value or security document.

The data carrier further contains two opaque white layers with a white opaque appearance that have been applied to the opposite main surfaces of the substrate. Each of the opaque white layers consists of a sequence of two or more sublayers, ranging from the lowermost white layer to an uppermost white layer.

The data carrier also contains a machine-readable security feature comprising a machine-readable feature material present in at least one of the sublayers of at least one of the opaque white layers. What is meant by the presence of the machine-readable feature material in at least one of the sublayers of at least one of the opaque white layers is that the feature material is in the form of a homogeneous distribution in the respective layer.

In the context of this description, an opaque white layer is the layer sequence that extends from a lowermost white layer to an uppermost white layer. The lowermost and uppermost white layers are included in each case, and so are part of the layer sequence of the opaque white layer. Between the lowermost and uppermost white layers, there may be further white layers, but also transparent layers. The intermediate layers are likewise part of the opaque white layer. The lowermost layer refers to the layer closest to the substrate, and the uppermost layer to the layer of the layer stack of the opaque white layer that is furthest from the substrate.

The sublayers of an opaque white layer typically have a thickness between 1 μm and 10 μm, preferably between 3 μm and 10 μm. The sublayers may consist of the same or different varnishes and may each be transparent or white or cloudy. The sublayers may contain various loadings, especially organic or inorganic white pigments or scattering agents for a white color impression. Advantageous white pigments are, for example, TiO₂ or SiO₂, but organic scattering agents are also useful. The scattering particles may have a round, sharp-edged or fibrous morphology.

In addition, the opaque white layer has a rough surface for good color uptake. This can be achieved in particular by the addition of relatively large particles (typically >10 μm) dispersed in the varnish. These particles may be identical to or different from the white pigments.

The sequence of the varnishes of the sublayers is advantageously chosen such that there is a permanently good adhesion between successive layers and that thin uniform layers can be printed. The opaque white layer is preferably printed onto the substrate by intaglio printing.

Windows can be created by providing cutouts in one of the two opaque white layers (one-sided windows) and/or congruent cutouts in the opposite opaque white layers on both sides (two-sided windows).

With their described properties, the opaque white layers provide a white opaque impression and a rough surface for good color uptake, such that the substrate with the two opaque white layers applied has similar behavior to paper on printing, in spite of the presence of polymer layer.

Within the scope of this description, a sublayer of an opaque white layer containing a machine-readable feature material is also referred to as an embedding layer. According to the invention, therefore, at least one of the two opaque white layers contains such an embedding layer. Each opaque white layer may contain exactly one embedding layer or even several embedding layers. It is also possible for all sublayers of an opaque white layer or at least all white sublayers to be embedding layers.

In an advantageous configuration, the machine-readable feature material is an optically readable feature material, i.e. a feature material which is excitable to emission of light (signal light) by illumination with light (illumination light), for example by luminescence, by scattering with spectral alteration via narrowband absorption or by Raman scattering. Preferably, the machine-readable feature material is a luminescent material, more preferably an IR-IR luminescent material, i.e. an infrared-excitable luminescent material that luminesces in the infrared. An IR absorber or Raman scattering agent can also be used as a machine-readable feature material.

When an optically readable feature material is used, the scattering of illumination light and signal light in the opaque white layer, both in the feature-containing and non-feature-containing layers, leads to higher feature intensity compared to introduction variants in which there is less scattering, for example an introduction in a window, or in the case of an introduction where the scattering agents are further away from the feature material particles, for instance when they are introduced into the volume of a polymer substrate.

Without wishing to be bound by any specific explanation, the following mechanisms in particular contribute to higher feature intensity according to current understanding: Firstly, the scattering of the illumination light leads to a longer path length of the illumination light in the feature-bearing layers, such that it is absorbed with higher efficiency by a feature particle. This has a particularly strong effect when there is a low concentration of feature materials, i.e. feature particles that are far apart, and the light spot is small. Secondly, the scattering of the signal light has the effect that a portion of the signal light that is not emitted in the direction of the detector is deflected to the detector by a scattering agent and can contribute to the measurement. If the feature material is a luminescent material, the illumination light is usually referred to as excitation light and the signal light as luminescence light.

If a data carrier contains several different machine-readable feature materials, the aforementioned requirements and also those that follow are advantageously applicable to multiple, in particular to all, machine-readable feature materials, even though the outline of the requirement refers only to one feature material in the singular.

Advantageously, the machine-readable feature material is distributed throughout the area of the embedding layer. In particular, the machine-readable feature material is distributed uniformly, i.e. with essentially constant area density, in the respective embedding layer. This simplifies a completeness check of the data carrier.

Advantageously, the machine-readable feature material consists of particles having a grain size D50 of less than 3 μm; the grain size D50 of the particles is more preferably between 0.5 μm and 2 μm. In this way, the particles are sufficiently small to not interfere with the printing of the embedding layer.

The machine-readable feature material appropriately consists of essentially round particles with an aspect ratio of less than 1:2. This supports uniform distribution of the feature material in the embedding layer without formation of a preferential direction.

In an advantageous configuration, an embedding layer of the machine-readable feature material contains filler particles, for example white pigments, and the machine-readable feature material consists of particles no larger than the largest filler particles of the embedding layer, for example measured using the D50 diameter. The filler particles can thus serve as scattering agents for the illumination light and/or signal light, and separation of filler particles and feature material particles is avoided.

At least one sublayer of an opaque white layer that has been provided with machine-readable feature material advantageously occupies substantially the whole area of the data carrier, such that a completeness check of the data carrier is possible. This does not include any window regions in one or both opaque white layers.

In an advantageous variant of the invention, only one of the two opaque white layers includes a machine-readable feature material. As explained in detail hereinafter, the orientation of the data carrier in particular can thereby be easily detected in the check.

In another, likewise advantageous variant of the invention, a machine-readable feature material is present in each of the opaque white layers. As explained in detail hereinafter, it is possible in this way, for example, to distribute the desired total amount of feature material over twice the number of embedding layers, or to increase the total amount of feature material per layer with the same feature load. The opposite opaque white layers may be provided with the same or different feature materials. The latter also allows simple detection of the orientation of the data carrier in the test.

In a preferred design, the machine-readable feature material is present in each case in exactly one of the sublayers of the two opaque white layers.

In an advantageous variant of the invention, the machine-readable feature material is present solely in the uppermost sublayer of one or both opaque white layers. The machine-readable feature material preferably consists of particles having a dimension that essentially corresponds to the layer thickness of the embedding layer or is less than the layer thickness of the embedding layer.

In another, likewise advantageous variant of the invention, the machine-readable feature material is present only in a deeper sublayer, preferably solely in the second-from-uppermost sublayer of one or both opaque white layers. The machine-readable feature material preferably consists of particles having a dimension smaller than the layer thickness of the embedding layer. The advantages associated with each of these two variants of the invention are elucidated in detail further down.

In a further, likewise advantageous variant of the invention, a machine-readable feature material is present in several sublayers of one or both opaque white layers.

In an appropriate design, the same feature material is present in different sublayers.

Introduction into several sublayers allows accommodation of a particularly high total amount of feature material in the opaque white layer.

Alternatively, different feature materials may advantageously be provided in different sublayers. For example, different but mutually interacting feature materials may be present in different sublayers. This increases forgery security since the feature signal cannot be simulated by a single feature material. Moreover, machine-readable feature materials with different particle sizes may also be present in different sublayers, where smaller particles are disposed in lower sublayers and larger particles in the uppermost sublayer of an opaque white layer, for example measured using the D50 diameter. Machine-readable feature materials with different particle hardness may also be present in different sublayers, with harder particles in deeper sublayers and softer particles in the uppermost sublayer of an opaque white layer, measured, for example, using Mohs hardness.

In another advantageous variant of the invention, a feature material with large particles is introduced into a deeper sublayer of an opaque white layer and stabilized by the adjacent higher sublayer. This variant is based on the inventors' observation that the sublayers, in particular the deeper sublayer, are thinner in the dry state than in the wet state, and that large particles embedded thereby, which are still fully embedded into a deeper layer in the wet state, protrude out of their actual embedding layer in the dry state and into the adjacent higher sublayer and are stabilized by the latter. In addition, the particles can also protect the higher sublayer from abrasion.

In a further advantageous configuration, the opaque white layers are designed such that they have an opacity >1.42 or a reflectance of more than 30% or even more than 50% in the infrared, especially between 800 nm and 2000 nm. This can be achieved by adjustment of the amount, but also by adjustment of the particle size, of the white pigments in the white sublayers of the opaque white layers. In order to prevent overlapping of white pigment aggregates at a high filling level, what are called extenders are advantageously used for dilution of the white pigments. The machine-readable feature material itself can be used particularly advantageously for this purpose, such that no separate extender is required.

In a further development of the invention, at least one of the sublayers includes a masking material that in particular has a chemical composition matched to the machine-readable feature material but has no feature effect, and hence makes it difficult for a potential forger to chemically analyze the feature material. The matched chemical composition may have, for example, the same crystal structure as the feature material, or contain some of the same elements as the feature material, or contain the same elements as the feature material but in different proportions. The masking material is preferably present in a higher sublayer or in the same sublayer as the machine-readable feature material.

The masking material may have the same grain size distribution as the feature material, but it may also advantageously have a larger average grain size than the feature material, such that the masking material particles additionally protect the feature material particles from abrasion. In a further variant of the invention, the particles of the masking material have a wider grain size distribution than the feature material, where the masking material contains larger particles than the feature material. The masking material may also have a bimodal size distribution and hence consist of smaller and larger particles. In both cases, the largest masking material particles protect the feature material from abrasion; at the same time, even when the larger masking material particles are lost, smaller masking material particles will remain in order to assure the desired masking.

The substrate of the data carrier is advantageously formed by a polymer substrate or by a composite substrate having at least one polymer layer, for example a composite substrate having the layer sequence of film/paper/film. Useful polymers for the polymer layer or polymer substrate especially include biaxially oriented polypropylene (BOPP), polyethylene terephthalate (PET), polypropylene (PP) or polyamide (PA). Particular preference is given here to the use of biaxially oriented polypropylene (BOPP).

The invention also includes a method of producing a data carrier of the type described, in which
a substrate comprising at least one transparent polymer layer and having two opposite main surfaces is provided,
two opaque white layers having a white opaque appearance are applied to the opposite main surfaces of the substrate and are each formed from a sequence of two or more sublayers ranging from a lowermost white layer to an uppermost white layer, and
at least one of the sublayers of at least one of the opaque white layers is produced with a machine-readable feature material in order to form a machine-readable security feature.

The sublayers of the opaque white layers are appropriately printed on, preferably by the intaglio printing method.

In the process, the machine-readable feature material is advantageously ground to the desired grain size or provided with the desired grain size and added to the varnish of the sublayer(s) envisaged for the embedding. The varnish is then applied together with the added feature material, and hence an essentially uniform feature material distribution in the embedding layer is achieved.

The present invention further relates to a method of verifying the authenticity of the data carrier of the invention, comprising the step of providing the data carrier and the step of reading the machine-readable security feature comprising a machine-readable feature material, where the reading uses in particular the scatter of illumination light and signal light in the opaque white layer for the verifying of the authenticity of the data carrier.

Further working examples and advantages of the invention will be elucidated hereinafter with reference to the figures, the representation of which dispenses with reproduction to scale and in proportion in order to increase clarity.

The figures show:

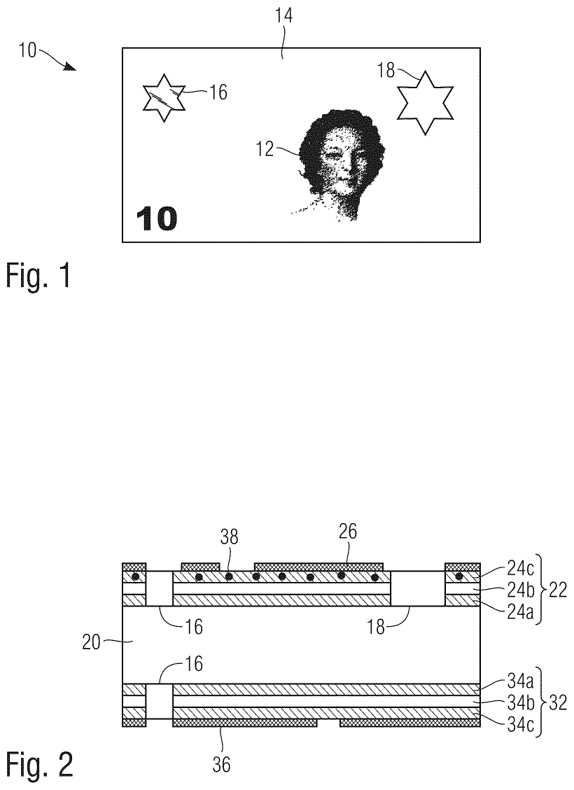

FIG. 1 a schematic of a polymer banknote with a machine-readable security feature of the invention,

FIG. 2 a schematic of the cross section of the structure of a banknote in a working example of the invention in which the feature material is present solely in the uppermost sublayer of the opaque white layer,

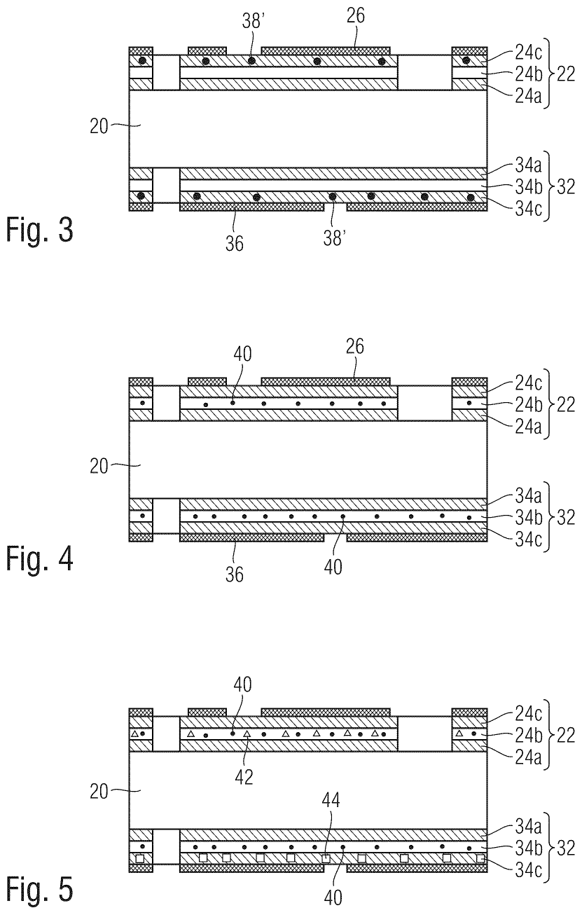

FIG. 3 a modification of the working example of FIG. 2 in which a feature-loaded opaque white layer is present on both sides of the substrate,

FIG. 4 another working example of the invention in which the feature material is present only in the second-from-uppermost sublayer of the opaque white layers,

FIG. 5 a modification of the working example of FIG. 4 with additional masking material,

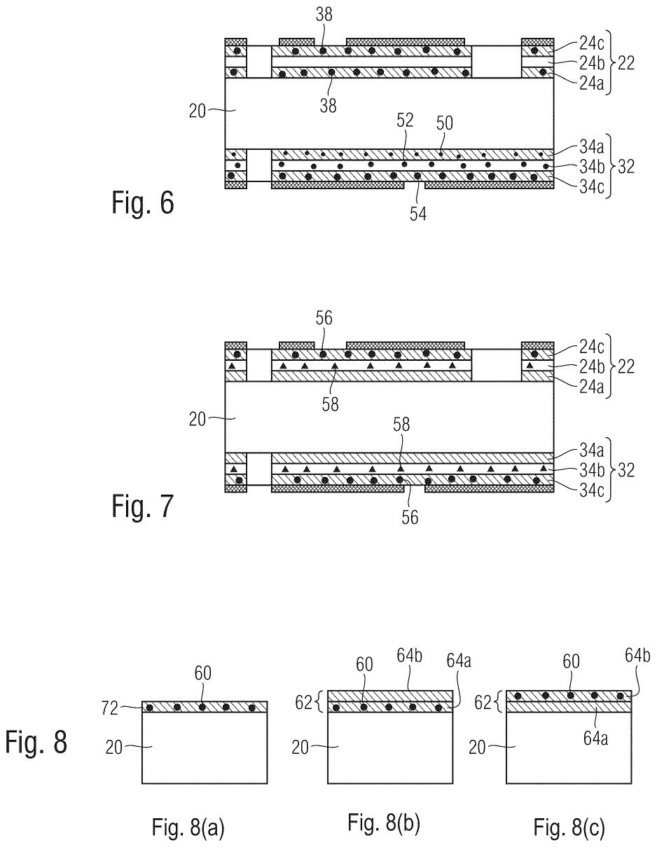

FIG. 6 a further working example of the invention in which the feature material is present in several sublayers of the opaque white layers,

FIG. 7 a working example having a first feature material in the uppermost sublayer and a second, supplementary feature material in the second-from-uppermost sublayer of the opaque white layers, and

FIG. 8 layer structures for comparative measurements of feature intensity in a conventional design (FIG. 8a) and two designs of the invention (FIG. 8b, FIG. 8c).

The invention will now be elucidated by the example of banknotes. FIG. 1 shows, in a schematic diagram, a polymer banknote 10 which, in addition to conventional printed images 12 and security elements, is also equipped with a machine-readable security feature 14 of the invention that occupies the full area of the banknote 10 except for the regions of the windows 16, 18.

FIGS. 2 to 7 illustrate several advantageous working examples, where the figures each show cross sections of the layers of a polymer banknote of the invention that are essential to the present invention. In the working examples, the banknote 10 in each case contains a transparent polymer substrate 20 which is preferably formed by a film of biaxially oriented polypropylene (BOPP).

To each of the opposite main surfaces of the substrate 20 has been applied an opaque white layer 22 and 32 with a white opaque appearance. Each of the two opaque white layers 22, 32 consists of several sublayers, typically two to five. The figures show, for illustration, opaque white layers with three sublayers 24a, 24b, 24c and 34a, 34b, 34c, each of which ranges from a lowermost white layer 24a or 34a to an uppermost white layer 24c or 34c. The lowermost layer refers to the layer closest to the substrate, and the uppermost layer to the layer of the layer stack of the opaque white layer 22 or 32 that is furthest from the substrate. Between the lowermost and uppermost white layers, there may be further, also transparent layers 24b, 34b that are likewise regarded as part of the opaque white layer 22 and 32 respectively.

As already elucidated in general terms above, the opaque white layers 22, 32 have an overall white opaque impression and provide a rough surface for good color uptake, such that the polymer substrate 20 together with the two opaque white layers 22, 32 behaves similarly to a paper substrate on printing. In the case of a finished banknote 10, desired prints 26, 36 and, if necessary, white functional and protective layers are applied to the opaque white layers 22, 32, as shown schematically in FIG. 2.

The opaque white layers 22, 32 cover the entire surface area on the front and back of the banknote 10 except for the half-window 18, on the front side only here, and the double-sided window 16, i.e. on the front and back side.

In order to equip the banknote 10 with the desired machine-readable security feature, in the working example of FIG. 2, the uppermost sublayer 24c of the opaque white layer 22 is admixed uniformly with a machine-readable feature material 38, for example with an IR-IR luminescent material, i.e. a luminescent material which is excitable in the infrared spectral region and also luminescent in the infrared spectral region. Alternatively, the feature material 38 may also include an IR absorber.

The areas provided with a feature material 38 therefore extend up to the window regions 16, 18 over the entire surface area of the banknote 10, such that a completeness check of the banknote can be carried out in the authenticity check. The window areas 16, 18, on the other hand, contain no machine-readable feature material, and therefore the desired high transparency of the window regions 16, 18 is not impaired by the machine-readable modification of the opaque white layer 22.

Because they are embedded not into an external print but into the deeper opaque white layer 22, the feature materials 38 are well protected against abrasion during the lifetime of the banknote 10. In fact, in the case of severe abrasion that already attacks the opaque white layer and hence the feature material 38, the visual appearance of banknote 10 is generally so severely impaired that the banknote is deemed unfit and withdrawn from circulation.

By contrast, feature materials that are conventionally added to one of the prints 26, 36, are subject to distinctly severe abrasion. In the case of a heavily stressed banknote, a sufficient amount of feature-laden ink may have been rubbed off that the feature signal is no longer sufficient for a successful authenticity check, even though the banknote is still considered fit for use in a quality control based on visual appearance. Moreover, only relatively small feature volumes can be included in a print 26, 36, and even a completeness check is usually impossible since the prints 26, 36 are not present over the full area of the banknote 10.

In order to ensure a good introducibility of the feature material 38 into the sublayer 24c, the size of the feature material particles is chosen such that it is comparable to the layer thickness of the sublayer 24c. Specifically, the white sublayer 24c, for example, has a layer thickness of 3 μm, while the D50 particle size of feature material 38 is about 2 μm.

In the working example of FIG. 2, the feature material 38 is present solely in the opaque white layer on one side, for example the front of the banknote 10, and hence also enables a check of the orientation of the banknote. In the case of an authenticity check, two sensors may be used on the top side or bottom side of the banknotes to be checked, in order to detect the signal of feature material 38 with the same intensity, irrespective of the relative orientation of the banknote 10. However, even a single sensor disposed, for example, on the top of the notes to be tested may be sufficient for the detection, since the polymer substrate 20, in spite of the two-sided opaque white layer 22, 32, transmits a sufficient amount of excitation and luminescence radiation in order to enable detection of feature material 38 even when the banknote 10 is turned over.

In the first embodiment illustrated in FIG. 2, a feature material 38 is introduced solely into the uppermost layer 24c of the opaque white layer 22. Since the feature material particles 38 are relatively large on the scale of the layer thickness of the sublayer 24c, they increase the roughness of the opaque white layer 22 overall and hence improve its color uptake. The two deeper sublayers 24b and 24a of the opaque white layer 22 remain unchanged in this configuration, and so the adhesion of the opaque white layer to the substrate 20 and to any layers above is not disrupted.

In addition, the uppermost layer 24c of the opaque white layer 22 typically already contains relatively large filler particles in order to assure the required surface roughness for color uptake, and so even the feature material particles 38 can be dispersed particularly efficiently in this sublayer. This can be ensured either directly by the action of the other fillers and/or in that the varnish used for the uppermost layer 24c is designed for the dispersion of large particles.

A further advantage of the above first working example is that the near-surface position of the feature material 38 ensures high excitation and detection efficiency in the authenticity check.

In the case of modification of the uppermost sublayer 24c of the opaque white layer 22 with a feature material, it has been found to be useful when the feature material particles have a D50 diameter of less than 3 μm, advantageously of not more than 2 μm, but at the same time more than 0.5 μm. The D99 diameter should be less than 10 μm, preferably less than 6 μm. Thus, the feature material particles are in a similar size range to the white pigments that are typically used and can be efficiently incorporated into a typically 3 to 10 μm-thick uppermost sublayer. Such a choice of the feature material particles advantageously results in the already mentioned additional increase in surface roughness, while at the same time good processibility and good printing properties of the varnish are assured.

With reference to the working example of FIG. 3, it is also advantageous to provide each of the opaque white layers 22, 32 on the two opposite sides of the banknote 10 with a machine-readable feature material. The desired total amount of feature material, compared to a merely single-sided introduction of feature material, can then be distributed over twice the number of embedding layers, such that the feature load per layer is only half as large. As a result, the properties of the embedding layers are altered to a lesser degree than in the case of single-sided introduction. Alternatively, with the same feature load, the total amount of feature material per layer can be increased. In the working example shown, only the uppermost sublayer 24c, 34c of the opaque white layer 22 and 32 in each case is provided with feature material, in the present case with the same machine-readable feature material 38′. Compared to the layer 24c of the configuration of FIG. 2, the feature load of layers 24c, 34c can be reduced, for example halved.

The opposite opaque white layers 22, 32 can also be provided with different feature materials in order to enable detection of banknote orientation in the authenticity check. It is generally possible for one or more sublayers 24a-c, 34a-c of the opaque white layers 22, 32 on each side to be provided with the same or different machine-readable feature materials.

The machine-readable feature material used may consist of inorganic particles, which are generally very hard. This increases the abrasion resistance of the opaque white layer 22, but on the other hand also harbors the risk of scratching of the printing plates for the visible print 26. It is therefore also possible to use a feature material 38 with soft particles, for example with feature material particles in which at least the outside is made of a polymer. The feature materials with soft particles are, for example, organic or organometallic feature materials dissolved or dispersed in a polymer and/or polymer-encapsulated inorganic, organic or organometallic feature materials. In a further embodiment, it is possible to provide inorganic feature materials having a shell of nanoparticles or having a coating, for instance of SiO₂, in order to achieve softer behavior coupled with good compatibility with common printing inks.

In a second embodiment of the invention, with reference to FIG. 4, a machine-readable feature material 40 is introduced only into a deeper sublayer of the opaque white layer 22, preferably into the second-from-uppermost sublayer 24b. This is advantageous particularly when hard feature material particles 40, for example formed from inorganic particles, are to be used.

Since the hard feature material particles 40 are then present in a deeper sublayer, they do not lead to scratching of the printing plates for the visible print 26.

In the second configuration, the abrasion protection of the feature material 40 is even further increased compared to embedding of the feature material into the uppermost sublayer 24c. The scattering of the excitation light at the white layer 24c above the embedding layer 24b also leads to lateral fanning-out of the excitation light, such that a high excitation efficiency can be achieved even with a small excitation spot and a low feature material load. In addition, feature materials with their own surface color can also be used inconspicuously in the lower sublayers.

In the case of modification of a deeper sublayer of the opaque white layer 22 with a feature material, it has been found to be useful when the feature matter particles have a D50 diameter of less than 2 μm, advantageously not more than 1.5 μm, but at the same time more than 0.5 μm. The D99 diameter should be less than 8 μm, preferably less than 6 μm. Thus, the feature material particles are in a similar size range to the white pigments that are typically used and can be efficiently incorporated into a typically 3 to 10 μm-thick deeper layer. On introduction of feature material into a deeper sublayer, somewhat finer particles are advantageously used in order to enable better print quality in the subsequent printing of the higher sublayers of the opaque white layer. These requirements are applicable particularly when the deeper sublayer is the lower layer of a two-layer opaque white layer.

In the working example of FIG. 4, each of the two opaque white layers 22, 32 is provided with the same feature material 40. But it is also possible, as in FIG. 3, to use different feature materials in the opaque white layers on the two sides in order to be able to easily detect the orientation of the banknote in the authenticity check.

The first and second configurations can also be combined, such that, for example, a feature material 40, as in FIG. 4, is introduced into the second-from-uppermost sublayer 24b of the opaque white layer 22, while, on the opposite side of the substrate, the same or a different feature material is introduced into the uppermost sublayer 34c of the opaque white layer 32.

The feature material, in all configurations may be mixed with a masking material, which makes it difficult for a potential forger to chemically analyze the feature material used. In this regard, FIG. 5 shows a variation of the configuration of FIG. 4 in which a masking material 42 has been introduced into the second-from-uppermost sublayer 24b of the opaque white layer 22 in addition to the feature material 40 and has, for example, the same particle size distribution as the feature material 40.

As illustrated by the opaque white layer 32 on the opposite side, a masking material 44 can also be introduced into the uppermost sublayer 34c of the opaque white layer even though the feature material 40 is present in the second-from-uppermost layer 34b. In this case, a larger grain size is advantageously used for the masking material 44, firstly to increase the roughness of the opaque white layer and secondly to protect the deeper-lying feature material particles from abrasion.

FIG. 6 illustrates a third configuration of the invention in which a feature material is introduced not only into one but into several sublayers of an opaque white layer. In particular, all white sublayers 24a, 24c or even all sublayers 34a, 34b, 34c of an opaque white layer may be provided with feature material.

In the working example, the same machine-readable feature material 38 has been introduced into all white sublayers 24a, 24c in the upper opaque white layer 22 in order to increase the maximum incorporatable amount of feature material. Protection against abrasion is thereby increased; in addition, partial abrasion of the upper sublayer 24c can be detected via a proportionately lower feature intensity, without the risk of a complete loss of feature intensity because of the good protection of the feature material in the lower sublayer 24a. In the uppermost white sublayer 24c, it is also possible to use large feature material particles that increase the roughness of the opaque white layer 22 and hence improve color uptake.

As illustrated with reference to the lower opaque white layer 32, feature material can be introduced not only into the white sublayers 34a, 34c, but also into all, i.e. also the transparent, sublayers 34b of an opaque white layer, in order to be able to introduce a maximum amount of feature material into the opaque white layer 32.

It is also possible to introduce different machine-readable feature materials 50, 52, 54 into the different sublayers. This variant has the advantage that the banknote can be withdrawn from circulation in a controlled manner when the outer sublayer (and with it the feature materials that bear it and the signal that they generate) is rubbed off, while authenticity is still unambiguously proved by means of the inner layer.

In particular, in this variant, feature materials with smaller particles 50, 52 can be introduced into deeper layers 34b and 34a, and a feature material with larger particles 54 into the uppermost layer 34c. The use of finer particles in the deeper sublayers 34a, 34b enables good pressure control in the subsequent printing of the higher sublayers, while the large particles of the uppermost sublayer 34c increase the roughness of the opaque white layer 32.

In another variant, feature materials with hard particles can be introduced into deeper layers 34b or 34a, and a feature material with soft particles into the uppermost sublayer 34c. It is likewise possible that visually conspicuous feature materials for masking are introduced into lower layers 34b and 34a, and a visually inconspicuous feature material into the uppermost sublayer 34c.

Different sublayers may also be provided with interacting feature materials, for example with an IR-excitable luminescent material on the one hand and an IR absorber on the other hand, or with two luminescent materials having energy transfer. If different feature materials are used in sublayers 34a-c, relative feature intensity can also be used as a measure of abrasion and hence the remaining fitness of the banknote 10, while authenticity is still unambiguously proved by means of the inner layer.

### Example 1: Feature Material in Uppermost Sublayer

In a specific working example according to the principle of FIG. 2, the machine-readable feature material 38 used is a thulium-doped lithium niobate, the production of which is described in example 2 of document DE 10 2010 026 627 A1. Grinding in an air jet mill adjusts the grain size of the feature material particles to D99=5-6 μm and D50=1.5-2 μm. On excitation with IR radiation at about 800 nm, the feature material shows characteristic luminescence in the infrared at about 1800 nm.

The polymer substrate 20 used is a 60 μm-thick film of biaxially oriented polypropylene (BOPP). Adhesion properties can be improved by applying a 2 μm-thick transparent varnish layer as primer to the BOPP substrate (not shown in FIG. 2).

Subsequently, three superposed sublayers 24a-c and 34a-c are applied in each case to the polymer substrate 20 by printing with an intaglio printing system on each of the two sides. The average layer thickness for the lower two sublayers 24a, 24b and 34a, 34b is 2 μm; the average layer thickness of the upper sublayers 24c, 34c is 3 μm in each case.

For the production of the sublayers, the varnish used is a commercially available intaglio-capable thermally curing aqueous aliphatic urethane acrylate copolymer dispersion to which 10% by weight of titanium dioxide with a D50 of less than 1 μm has been added as white pigments. The feature material 38 is selectively added in a proportion of 1% by weight only to the varnish used for printing the uppermost sublayer 24c.

The machine-readable security feature thus created shows the advantages described above; in particular, the application of the uppermost sublayer 24c is not hindered because no feature material has been incorporated in the lower sublayers 24a, 24b. The roughness of the uppermost sublayer 24c is increased by the feature material; moreover, the efficiency of feature material 38 is particularly high compared to introduction into deeper sublayers. Given the relatively long emission wavelength of the thulium feature, the banknote 10 has a high transmittance, and so detection of the feature material 38 from the side of the substrate facing away from the embedding layer 24c is also possible with good efficiency.

### Example 2: Feature Material in a Deeper Sublayer

In a specific working example according to the principle of FIG. 4, the machine-readable feature material 40 used is an ytterbium-doped mixed yttrium-aluminum-chromium garnet, the production of which is described in example 2 of document DE 198 03 997 A1. Grinding in a stirred ball mill adjusts the grain size of the feature material particles to D99=2.5-3.5 μm and D50=0.5-1 μm. The particles produced have an aspect ratio of nearly 1. The feature material 40 has a green intrinsic color; when excited with IR radiation at 945 nm it shows characteristic luminescence in the infrared in the range of 950-1100 nm.

The layer structure of sublayers 24a-c, 34a-c is basically identical to the structure according to example 1, except that the feature material 40 in this example is selectively introduced in each case only into the varnish used for creation of the second-from-uppermost sublayers 24b, 34b.

The machine-readable security feature thus created shows the advantages described above; in particular, the application of the uppermost sublayer 24c, 34c is not hindered because feature material 40 has a suitable small grain size. Furthermore, the disruptive influence of the green intrinsic color of the feature material is minor compared to an introduction into an uppermost sublayer. Abrasion of feature material from the deeper embedding layers 24b, 34b is made more difficult, and the security feature has high efficiency even in the case of analysis with small excitation spots.

### Example 3: Feature Material in Lower Sublayer, With Masking Material

Proceeding from example 2, the feature material 40 can be masked using a masking material, as illustrated in FIG. 5. The masking material 42 used is, for example, a manganese-doped gadolinium-gallium garnet. The elements Gd, Ga and Mn that have additionally been found in an elemental analysis behave analogously to the elements Y/Yb, Al and Cr of the feature material and hence increase the number of plausible stoichiometries or mixed forms such as mixed Gd—Y garnets, mixed Al—Ga garnets or mixed Mn—Cr garnets.

In a first variant, the masking material 42 is used with the same grain size as the feature material 40 and is likewise incorporated into the second-from-uppermost sublayer 24b and 34b on both sides. This advantageously does not result in loss of the masking effect even if one of the uppermost sublayers 24c, 34c should be damaged.

In a second variant, the masking material 44 is used with a larger grain size, here for example with D99=5-6 μm and D50=1.5-2 μm, and is likewise introduced into the uppermost sublayer 24c and 34c on both sides. This advantageously increases the roughness of the opaque white layers 22, 32, and the hardness of the inorganic masking material particles 44 protects the underlying sublayer 24b, 34b with the feature material 40 from abrasion. In addition, an analysis of the feature material is made more difficult because the large masking material particles attract attention in an analysis and the smaller feature material particles are harder to identify and analyze.

### Example 4: Feature Material in Several Sublayers

In a specific working example according to the principle of FIG. 7, the structure of the substrate and the sublayers 24a-c, 34a-c basically follows the structure of example 1.

A first feature material 56 used is an ytterbium-doped yttrium phosphate with a grain size D99=8-9 μm and D50=2.5-3.5 μm which is selectively incorporated in each case into the uppermost sublayer 24c, 34c of the opaque white layers 22, 32 on both sides of the substrate 20. On excitation with radiation of wavelength 945 nm, the first feature material 56 shows a characteristic luminescence in the range of 950-1100 nm with an elevated proportion at wavelengths below 1000 nm.

A second feature material 58 used is the ytterbium-doped mixed yttrium-aluminum-chromium garnet described in example 2 which is selectively incorporated in each case into the second-from-uppermost sublayer 24b, 34b of the opaque white layers 22, 32 on both sides of the substrate 20. On excitation with radiation of wavelength 945 nm, the second feature material 58 shows a characteristic luminescence in the range of 950-1100 nm with an elevated proportion at wavelengths above 1000 nm.

The machine-readable security feature thus created shows the respective advantages of examples 1 and 2. However, the simultaneous use of the interacting feature materials in different sublayers gives rise to additional synergistic effects.

To wit, if the sublayers 24b, 24c or 34b, 34c are present in full, the respective spectra of the feature materials 56, 58 are mutually complementary and act like a single feature. It is therefore not immediately apparent to a forger that the feature materials 56, 58 are not present in the same layer.

If the uppermost sublayer 24c or 34c is partly removed or damaged, for example by the natural stresses on a banknote in circulation or by deliberate manipulation in the context of attempted forgery, there will be an increase in the relative spectral components above 1000 nm or decrease in the relative spectral components below 1000 nm in the emission spectrum detected. It is thus possible to evaluate the fitness of the banknote for circulation via the interplay of the two sublayers and to detect manipulation attempts in which the uppermost sublayer 24c, 34c has been completely or partly damaged.

### Example 5: Feature Material With Soft Particles

In a specific working example according to the principle of FIG. 3, the machine-readable feature material 38′ used is spheres of PMMA with the dissolved IR absorber CKK-55 (manufacturer: Fujifilm Imaging Colorants), the production of which is described in example 7 of document DE 10 2015 0145 26 A1. Grinding in an air jet mill adjusts the grain size of the feature material to D99=5.5 μm and D50=1.5-2 μm. The particles have an aspect ratio below 2:1. The feature material 38′ shows a characteristic absorption band in the region of 850 nm.

The feature material is installed into the respective uppermost sublayer 24c and 34c of the opaque white layers 22, 32 on both sides of the substrate. In addition to the advantages already mentioned, the low hardness and density of the polymer-based feature material 38′ by comparison to inorganic particles having the same grain size results in higher compatibility with standard printing inks, for example less significant settling characteristics and a lower tendency to scratch of printing plates.

### Comparative Measurements

FIG. 8 shows layer structures that have been used for comparative measurements of the feature intensity in a conventional design and two designs of the invention.

With reference to FIG. 8(b), an opaque white layer 62 has been applied to a transparent polymer substrate 20, consisting of two sublayers 64a, 64b, each of thickness 12 μm in the wet state. The two layers are formed from a clearcoat, for example an aqueous aliphatic urethane acrylate copolymer dispersion, with 20% titanium dioxide (rutile) as white pigment. The varnish used for the printing of the lower sublayer 64a was additionally admixed with 0.2% of an inorganic IR-IR luminescent material 60 that constitutes the machine-readable feature material. The luminescent material 60 has a grain size D50=2.5 μm and D99=6 μm, and so the luminescent particles can be efficiently introduced into one of the wet 12 μm-thick varnish layers. It is alternatively possible to use, in place of the IR-IR luminescent material, a Raman-active substance, in particular a Raman-active substance of increased surface area.

In the working example of FIG. 8(b), the lower sublayer 64a contains the machine-readable feature material 60; the upper sublayer 64b is feature-free.

FIG. 8(c) shows a further working example in which the feature material 60 in the stated amount was introduced only into the upper sublayer 64b, while the lower sublayer 64a is feature-free.

FIG. 8(a) shows a noninventive comparative example in which the opaque white layer 72 consists of a single layer into which the abovementioned amount of feature material 60 has been introduced. The configurations of FIG. 8(a) to (c) therefore all contain the same amount of feature material 60.

The luminescence of the feature material 60 is excited and detected from above, i.e. the side of the opaque white layers; a black background was placed beneath the substrate 20. The size of the measurement range was chosen such that it covers a large number of (about 100) feature material particles.

The measured feature intensities were normalized to the intensity of the comparative example of FIG. 8(a), the feature intensity of which is thus 100%.

Under the same excitation and detection conditions as in the comparative example, a feature intensity of 59% is measured in the first working example of FIG. 8(b). The particular advantage of this configuration, given sufficiently high feature intensity, is that the feature material particles 60 are well protected from abrasion, and because of the feature-free sublayer 64b there is no risk that printing plates for further printing will be scratched by hard feature material particles.

Under the same excitation and detection conditions as in the comparative example, a feature intensity of 159% is measured in the second working example of FIG. 8(c). The particular advantage of this configuration lies in a distinctly increased feature intensity for the same amount of feature material used. The mechanisms responsible for the increased feature intensity according to current understanding have already been described further up.

### LIST OF REFERENCE NUMERALS

10 polymer banknote
12 print images
14 machine-readable security feature
16 double-sided window
18 single-sided window
20 substrate
22 opaque white layer
24a, 24b, 24c sublayers
26 print
32 opaque white layer
34a, 34b, 34c sublayers
36 print
38, 38′ machine-readable feature material
40 machine-readable feature material
42, 44 masking material
50, 52, 54 different machine-readable feature materials
56, 58 interacting feature materials
60 luminescent material
62 opaque white layer
64a, 64b sublayers
72 opaque white layer

1.-17. (canceled)

18. A data carrier comprises:
a substrate comprising at least one transparent polymer layer and having two opposite main surfaces,
two opaque white layers having a white opaque appearance that have been applied to the opposite main surfaces of the substrate, where each of the opaque white layers consists of a sequence of two or more sublayers ranging from a lowermost white layer to an uppermost white layer, and
a machine-readable security feature comprising a machine-readable feature material present in at least one of the sublayers of at least one of the opaque white layers.

19. The data carrier according to claim 18, wherein the machine-readable feature material is an optically readable feature material.

20. The data carrier according to claim 18, wherein the machine-readable feature material consists of particles having a grain size D50 of less than 3 μm.

21. The data carrier according to claim 18, wherein the machine-readable feature material consists of essentially round particles with an aspect ratio of less than 1:2.

22. The data carrier according to claim 18, wherein an embedding layer of the machine-readable feature material contains filler particles, and in that the machine-readable feature material consists of particles that are no larger than the largest filler particles of the embedding layer.

23. The data carrier according to claim 18, wherein a machine-readable feature material is present in both opaque white layers.

24. The data carrier according to claim 18, wherein the machine-readable feature material is present in each case in exactly one of the sublayers of one or both opaque white layers.

25. The data carrier according to claim 18, wherein the machine-readable feature material is present solely in the uppermost sublayer of one or both opaque white layers, where the machine-readable feature material advantageously consists of particles having a dimension, that corresponds essentially to the layer thickness of the embedding layer or is less than the layer thickness of the embedding layer.

26. The data carrier according to claim 18, wherein the machine-readable feature material is present solely in a deeper sublayer, where the machine-readable feature material advantageously consists of particles with a dimension smaller than the layer thickness of the embedding layer.

27. The data carrier according to claim 18, wherein a machine-readable feature material is present in multiple sublayers of one or both opaque white layers.

28. The data carrier according to claim 27, wherein different feature materials are present in different sublayers.

29. The data carrier according to claim 28, wherein different, mutually interacting feature materials are present in different sublayers.

30. The data carrier according to claim 27, wherein machine-readable feature materials with different particle sizes are present in different sublayers of an opaque white layer, where smaller particles are disposed in deeper sublayers and larger particles in the uppermost sublayer of the opaque white layer.

31. The data carrier according to claim 28, wherein machine-readable feature materials with different particle hardness are present in different sublayers of an opaque white layer, where harder particles are disposed in deeper sublayers and softer particles in the uppermost sublayer of the opaque white layer.

32. The data carrier according to claim 18, wherein at least one of the sublayers includes a masking material which has a chemical composition matched to the machine-readable feature material but has no feature effect, where the masking material is present in a higher sublayer or in the same sublayer as the machine-readable feature material.

33. A method of producing a data carrier according to claim 18, in which
a substrate comprising at least one transparent polymer layer and having two opposite main surfaces is provided,
two opaque white layers having a white opaque appearance are applied to the opposite main surfaces of the substrate and are each formed from a sequence of two or more sublayers ranging from a lowermost white layer to an uppermost white layer, and
at least one of the sublayers of at least one of the opaque white layers is produced with a machine-readable feature material in order to form a machine-readable security feature.

34. A method of verifying the authenticity of the data carrier according to claim 18, comprising the step of providing the data carrier and the step of reading the machine-readable security feature comprising a machine-readable feature material, where the reading uses the scatter of illumination light and signal light in the opaque white layer for the verifying of the authenticity of the data carrier.
